(19) United States
(12) Patent Application Publication
(10) Pub. No.: US 2012/0102368 A1
(43) Pub. Date: Apr. 26, 2012

(54) COMMUNICATING ERRORS BETWEEN AN OPERATING SYSTEM AND INTERFACE LAYER

(75) Inventors: James Heit, Vadnais Heights, MN (US); Robert Bergerson, Blaine, MN (US); John Peters, Coon Rapids, MN (US); Jason Schultz, Plymouth, MN (US)

(73) Assignee: Unisys Corp., Blue Bell, PA (US)

(21) Appl. No.: 12/909,045

(22) Filed: Oct. 21, 2010

(51) Int. Cl. G06F 11/07; G06F 15/16

(52) U.S. Cl. 714/48; 709/227; 714/E11.025

(57) ABSTRACT

Error information may be made quickly and easily accessible to an administrator by logging communications attempts in the operating system of a server. When the interface processor resides outside of the operating system, the interface processor may provide indications to the operating system of communications attempts. Specifically, the interface processor may provide message packets to the pass-through communications processor of the operating system when SSL/TLS communications attempts fail to establish secure communications sessions. The message packets may include information useful for diagnosing errors in SSL/TLS communication failures such as errors in the creation and management of certificates, certificate trust, private and public keys, and/or cipher suites. The communications logs in the operating system may be reviewed and/or analyzed by an administrator with a log trace analysis application.

### TECHNICAL FIELD

The instant disclosure relates to error logging in computer systems. More specifically, the disclosure relates to systems and methods for communicating information between different layers of a computer system.

### BACKGROUND

In computer systems as illustrated in FIG. 1 communications processing was performed within the operating system. Logging of successful and/or failed communications attempts is performed by the communications processor in the operating system. FIG. 1 is a block diagram illustrating a conventional computer system. A system 110 includes a network interface card 112 coupled to a network such as, for example, an Ethernet network. The network interface card 112 communicates with a communications processor 116 in an operating system 114. The communications processor 116 may process, for example, TCP/IP packets. The communications processor 116 couples to other applications 118 executing within the operating system 114 to deliver information from the network 120 to the applications 118. When successful and/or failed communications attempts are made by remote clients to the system 110 through the network 120 and the network interface card 112, the operating system 114 may log information about the communication attempts because the communications attempts are processed within the operating system 114. Thus, error logs are produced in the operating system 114 for access by an administrator.

In modern computer systems, as illustrated in FIG. 2, the communications processor is only a pass-through to allow applications executing in an operating system to access a network. FIG. 2 is a block diagram illustrating a modern computer system. A system 210 includes a network interface card 212 coupled to a network 220. The system 210 also includes a system architecture interface layer (SAIL) 230 and an operating system 240. The SAIL 230 couples to the network interface card 212 through sockets 232 and couples to the operating system 240 through an interface processor 234. The operating system 240 couples to the SAIL 230 through a pass-through communications processor 242, which passes network communications to applications 244 executing in the operating system.

Because communications attempts are handled in the interface processor 234, which is outside of the operating system 240, the operating system 240 may not receive information regarding communications attempts. For example, if an inbound secure connection handshake fails, the operating system 240 would not receive an indication of the failure communications attempt. Thus, the error information would be unavailable for access by an administrator for diagnosing failed connection attempts or obtaining information regarding successful connection attempts.

### SUMMARY

According to one embodiment, a method includes receiving, at an interface, a connection attempt to an operating system. The method also includes logging the connection attempt in a first log at the interface. The method further includes sending, to the operating system, an indication of the connection attempt.

According to another embodiment, a computer program product includes a computer readable medium having code to receive, at an interface, a connection attempt to an operating system. The medium also includes code to log the connection attempt in a first log at the interface. The medium further includes code to send, to the operating system, an indication of the connection attempt.

According to yet another embodiment, a system includes a network interface card. The system also includes a system architecture interface layer (SAIL) coupled to the network interface card. The system further includes an operating system coupled to the SAIL. The operating system includes a pass-through communications processor. The SAIL includes an interface processor for indicating to the communications processor communications attempts received through the network interface card.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed system and methods, reference is now made to the following descriptions taken in conjunction with the accompanying drawings.

FIG. 1 is a block diagram illustrating a conventional computer system.

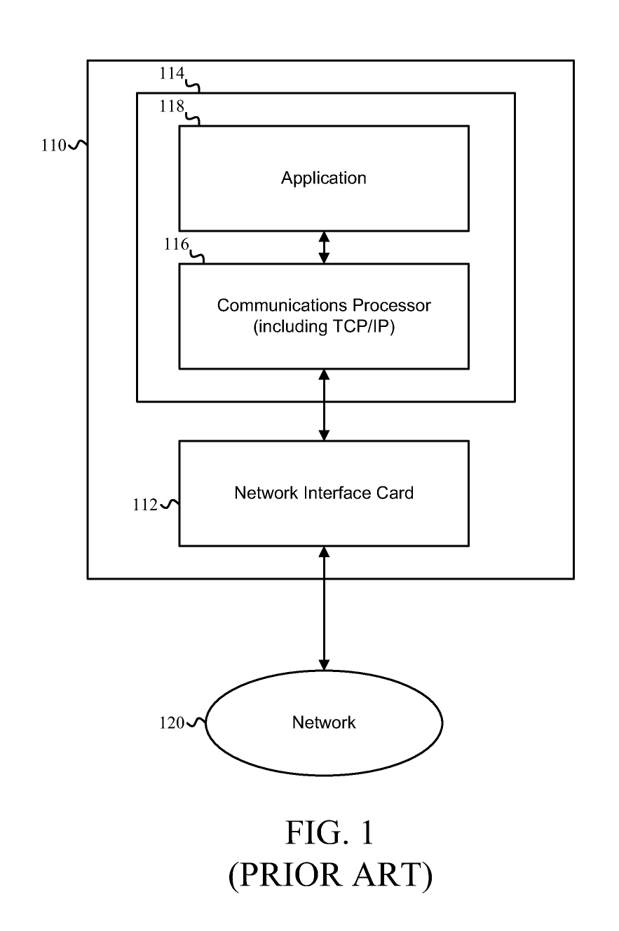

FIG. 2 is a block diagram illustrating a modern computer system.

FIG. 3 is a block diagram illustrating a system for sharing and/or analyzing a communications log according to one embodiment of the disclosure.

FIG. 4 is block diagram illustrating a data management system configured to store communications logs according to one embodiment of the disclosure.

FIG. 5 is a block diagram illustrating a computer system for storing and/or reviewing communications logs according to one embodiment of the disclosure.

FIG. 6 is a flow chart illustrating an exemplary method for communicating errors in a computer system according to one embodiment of the disclosure.

FIG. 7 is an example terminal input illustrating accessing a communications log file according to one embodiment of the disclosure.

FIG. 8 is an example terminal input illustrating accessing a communications log file according to another embodiment of the disclosure.

FIG. 9 is an example terminal output illustrating an exemplary communications log file entry according to one embodiment of the disclosure.

FIG. 10 is an example terminal output illustrating an exemplary communications log file entry according to another embodiment of the disclosure.

### DETAILED DESCRIPTION

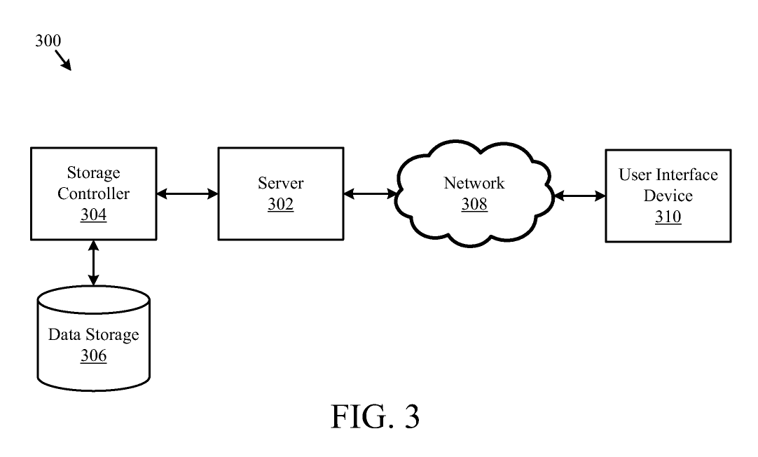

FIG. 3 illustrates one embodiment of a system 300 for establishing and logging communications attempts. The system 300 may include a server 302, a data storage device 306, a network 308, and a user interface device 310. In a further embodiment, the system 300 may include a storage controller 304, or storage server configured to manage data communications between the data storage device 306, and the server 302 or other components in communication with the network 308. In an alternative embodiment, the storage controller 304 may be coupled to the network 308.

In one embodiment, the user interface device 310 is referred to broadly and is intended to encompass a suitable processor-based device such as a desktop computer, a laptop computer, a personal digital assistant (PDA) or table computer, a smartphone or other a mobile communication device or organizer device having access to the network 308. In a further embodiment, the user interface device 310 may access the Internet or other wide area or local area network to access a web application or web service hosted by the server 302 and provide a user interface for enabling a user to enter or receive information. For example, the server 302 may allow access to communications log files stored in the data storage 306.

The network 308 may facilitate communications of data between the server 302 and the user interface device 310. The network 308 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate, one with another.

In one embodiment, the server 302 is configured to respond to communication attempts and log communications attempts in the data storage 306. Additionally, the server may access data stored in the data storage device 306 via a Storage Area Network (SAN) connection, a LAN, a data bus, or the like.

The data storage device 306 may include a hard disk, including hard disks arranged in an Redundant Array of Independent Disks (RAID) array, a tape storage drive comprising a magnetic tape data storage device, an optical storage device, or the like. In one embodiment, the data storage device 306 may store communications logs. The data may be arranged in a database and accessible through Structured Query Language (SQL) queries, or other data base query languages or operations.

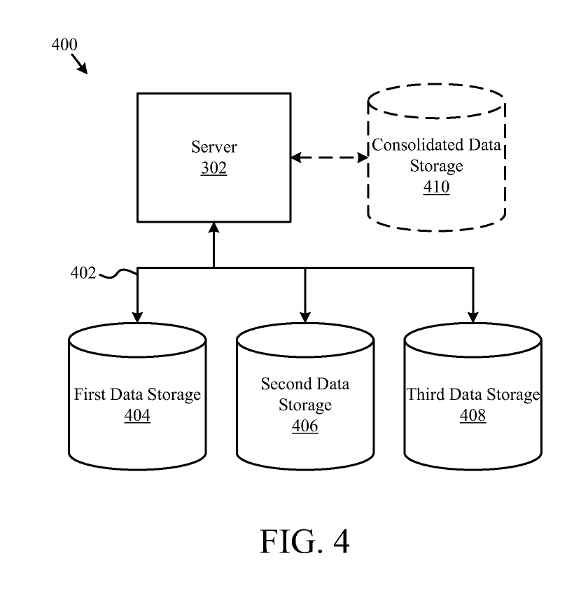

FIG. 4 illustrates one embodiment of a data management system 400 configured to store identification information. In one embodiment, the data management system 400 may include a server 302. The server 302 may be coupled to a data-bus 402. In one embodiment, the data management system 400 may also include a first data storage device 404, a second data storage device 406, and/or a third data storage device 408. In further embodiments, the data management system 400 may include additional data storage devices (not shown). In such an embodiment, each data storage device 404, 406, 408 may each host a separate database that may, in conjunction with the other databases, contain redundant data. Alternatively, the storage devices 404, 406, 408 may be arranged in a RAID configuration for storing a database or databases through may contain redundant data.

In one embodiment, the server 302 may submit a query to selected data storage devices 404, 406 to store or retrieve communication attempts. The server 302 may store the consolidated data set of logged communications in a consolidated data storage device 410. In such an embodiment, the server 302 may refer back to the consolidated data storage device 410 to obtain a set of data elements associated with a communications attempts. Alternatively, the server 302 may query each of the data storage devices 404, 406, 408 independently or in a distributed query to obtain the set of data elements associated with a communications attempt. In another alternative embodiment, multiple databases may be stored on a single consolidated data storage device 410.

The data management system 400 may also include files for accessing and/or processing the communications logs. In various embodiments, the server 302 may communicate with the data storage devices 404, 406, 408 over the data-bus 402. The data-bus 402 may comprise a SAN, a LAN, or the like. The communication infrastructure may include Ethernet, Fibre-Chanel Arbitrated Loop (FC-AL), Small Computer System Interface (SCSI), Serial Advanced Technology Attachment (SATA), Advanced Technology Attachment (ATA), and/or other similar data communication schemes associated with data storage and communication. For example, the server 302 may communicate indirectly with the data storage devices 404, 406, 408, 410; the server 302 first communicating with a storage server or the storage controller 404.

The server 302 may host a software application configured for responding to communications attempts and/or logging communications attempts. The software application may further include modules for interfacing with the data storage devices 404, 406, 408, 410, interfacing a network 308, interfacing with a user through the user interface device 310, and the like. In a further embodiment, the server 302 may host an engine, application plug-in, or application programming interface (API).

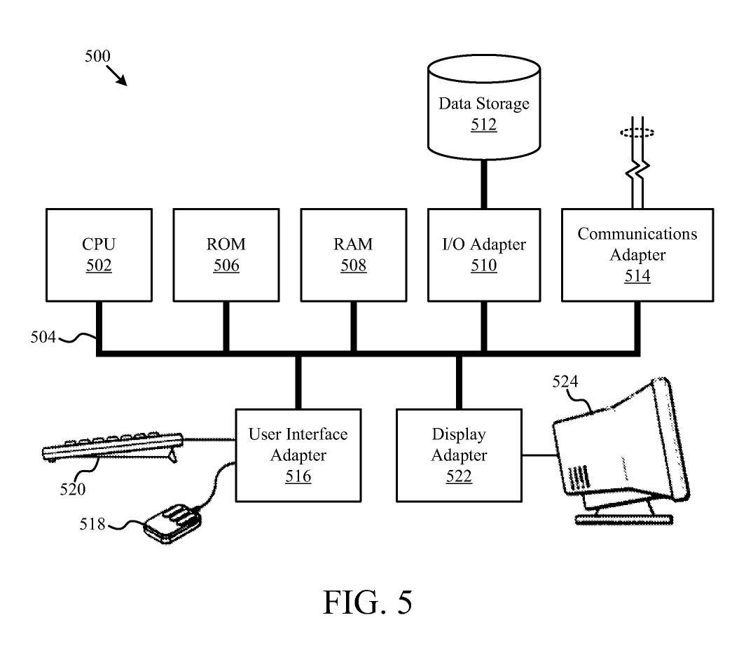

FIG. 5 illustrates a computer system 500 adapted according to certain embodiments of the server 302 and/or the user interface device 310. The central processing unit (“CPU”) 502 is coupled to the system bus 504. The CPU 502 may be a general purpose CPU or microprocessor, graphics processing unit (“GPU”), microcontroller, or the like. The present embodiments are not restricted by the architecture of the CPU 502 so long as the CPU 502, whether directly or indirectly, supports the modules and operations as described herein. The CPU 502 may execute the various logical instructions according to the present embodiments.

The computer system 500 also may include random access memory (RAM) 508, which may be SRAM, DRAM, SDRAM, or the like. The computer system 500 may utilize RAM 508 to store the various data structures used by a software application having code to store and/or analyze communications logs. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data.

The computer system 500 may also include an input/output (I/O) adapter 510, a communications adapter 514, a user interface adapter 516, and a display adapter 522. The I/O adapter 510 and/or the user interface adapter 516 may, in certain embodiments, enable a user to interact with the computer system 500 in order to attempt communications sessions. In a further embodiment, the display adapter 522 may display a graphical user interface associated with a software or web-based application for analyzing and/or reviewing communications logs.

The I/O adapter 510 may connect one or more storage devices 512, such as one or more of a hard drive, a compact disk (CD) drive, a floppy disk drive, and a tape drive, to the computer system 500. The communications adapter 514 may be adapted to couple the computer system 500 to the network 308, which may be one or more of a LAN, WAN, and/or the Internet. The user interface adapter 516 couples user input devices, such as a keyboard 520 and a pointing device 518, to the computer system 500. The display adapter 522 may be driven by the CPU 502 to control the display on the display device 524.

The applications of the present disclosure are not limited to the architecture of computer system 500. Rather the computer system 500 is provided as an example of one type of computing device that may be adapted to perform the functions of a server 302 and/or the user interface device 310. For example, any suitable processor-based device may be utilized including without limitation, including personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments.

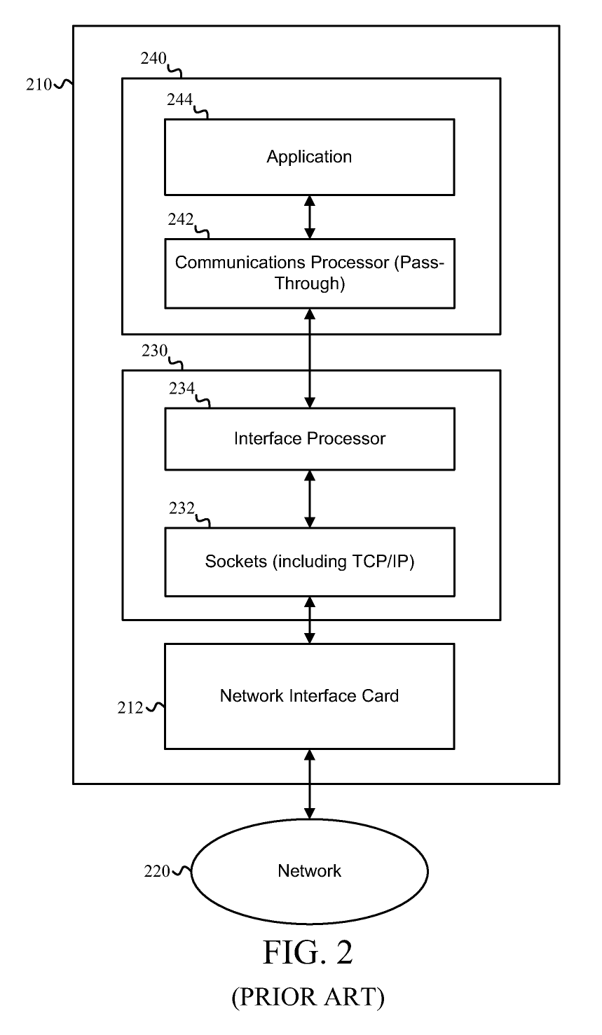

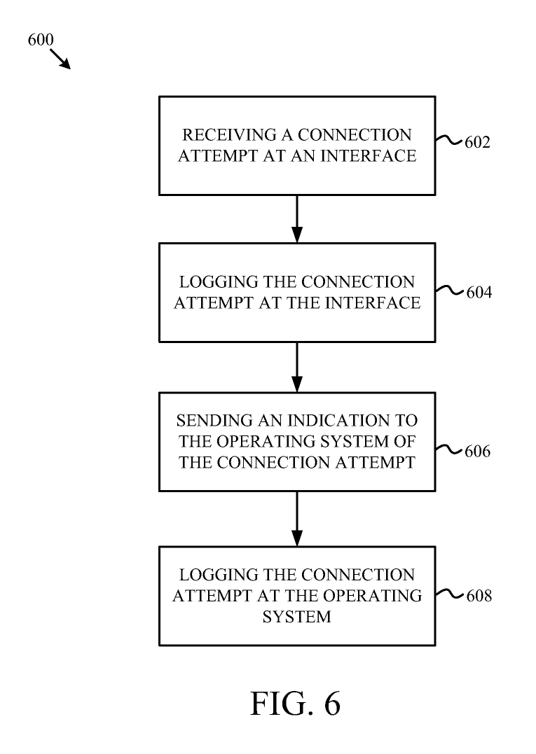

FIG. 6 is a flow chart illustrating an exemplary method for communicating errors in a computer system according to one embodiment of the disclosure. A method 600 will be described with reference to the server 210 illustrated in FIG. 2. At block 602 a connection attempt may be received at the network interface card 212 and delivered to the sockets 232. According to one embodiment, the connection attempt may be a secure sockets layer (SSL) connection and/or a transport layer security (TLS) connection, and the sockets 232 may be, for example, SAIL sockets. At block 604 the connection attempt may be logged in a first log by the interface processor 234. The interface processor 234 may be, for example, XNIOP. At block 606 the interface processor 234 sends an indication of the connection attempt to the pass-through communications processor 242 in the operating system 240. The operating system 240 may be the Unisys OS2200, and the pass-through communications processor 242 may be CPCommOS. According to one embodiment, the indication is a message packet including information such as IP address, protocol, port, date, and/or time. At block 608 the operating system 240 logs the connection attempt in a second log.

The communications attempts to be indicated by the interface processor 234 at block 606 may be configurable. According to one embodiment, an administrator may set indications to occur only when communications attempts fail to establish a communications session. According to another embodiment, an administrator may set indications to occur when communications attempts successfully establish a communications session. Additionally, indications may be configured to be turned on and off. For example, during a debug mode the indications of communications attempts may be turned on and reported to the operating system 240. After debugging has completed, normal mode is entered and the indications may be turned off.

Having the interface processor 234 report the communications attempts to the communications processor 242 allows the operating system 240 to maintain a communications log file including information regarding communications errors. For example, if a SSL and/or TLS handshake fails at the interface processor 234 the operating system 240 receives an indication of the error and stores the indication in a log file accessible by an administrator of the operating system 240. The log files of the operating system 240 may be reviewed and/or analyzed with, for example, a log trace analysis (LTA) application.

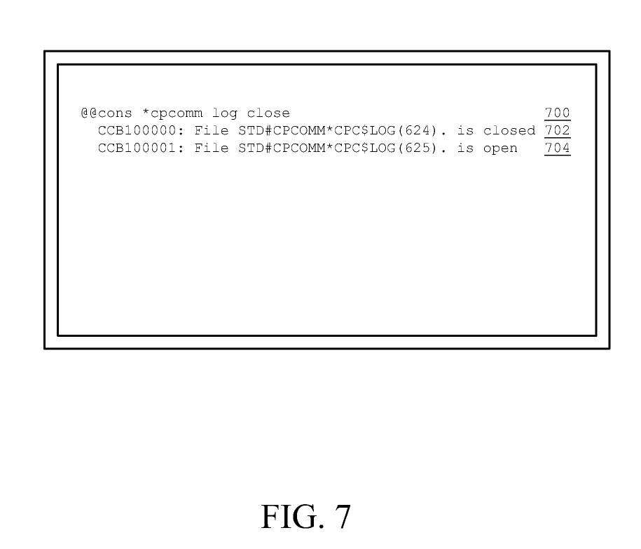

The communications log may be accessed through the operating system of a server. FIG. 7 is an example terminal input illustrating accessing a communications log file according to one embodiment of the disclosure. The outputs 702 and 704 are produced after the command 700 is issued. At output 702 the communications log in the pass-through communications processor is closed from receiving future network connection attempt indications. At output 704 a new communications log file in the pass-through communications processor is opened for receiving future network connection attempt indications. A log trace analyzer may open the log file shown in output 702 for analysis.

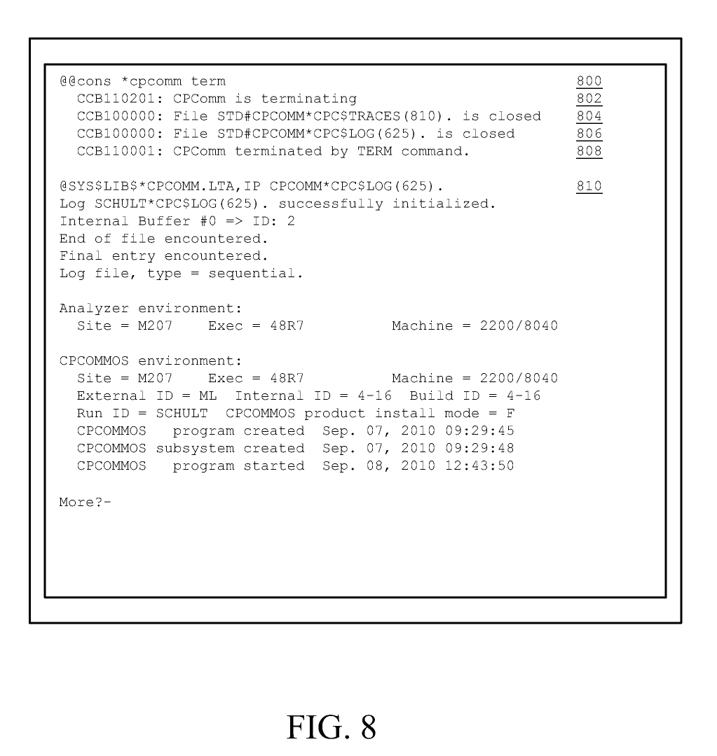

In another embodiment, the communications processor may be terminated to allow access to the communications log of the operating system. FIG. 8 is an example terminal input illustrating accessing a communications log file according to another embodiment of the disclosure. The outputs 802, 804, 806, 808, and 810 are produced after the command 800 is issued. At output 802 the communications processor may begin termination. At output 804 the communications processor trace file may be closed. At output 806 the communications processor log file including, for example, the logs described above with reference to block 608 of FIG. 6 may be closed. At output 808 the communications processor may be terminated. At output 810 the log trace analyzer may be executed. According to one embodiment, a log trace analyzer may be found in the CPCommOS installation file.

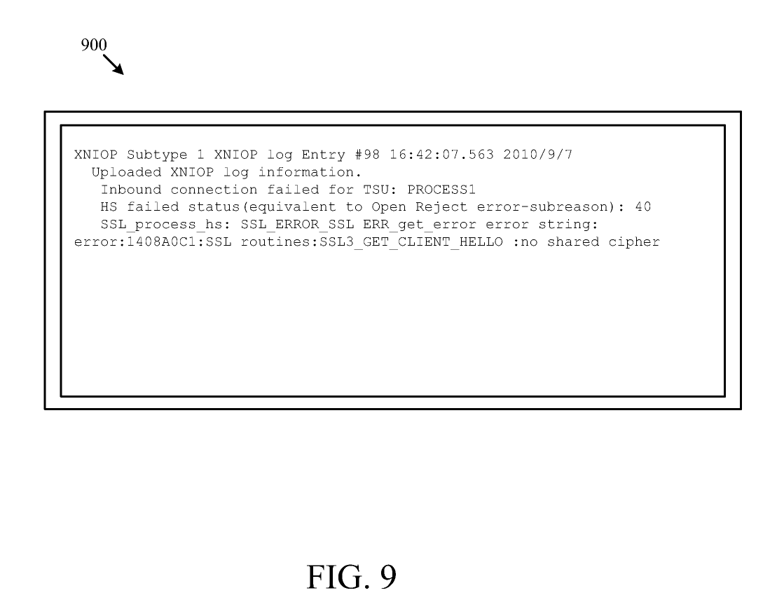

After the log trace analyzer has executed the log file may be analyzed. FIG. 9 is an example terminal output illustrating an exemplary communications log file entry according to one embodiment of the disclosure. A log file entry 900 may include information such as which CPCommOS application encountered an error (e.g., PROCESS1). The entry 900 may also include an alert code (e.g., 40), which may designate to the administrator that no matching cipher suites exist between the remote client and the server. Additionally, the entry 900 may include information captured by XNIOP by making calls to a library, such as the OpenSSL library, when a SSL and/or TLS handshake error occurred (e.g., SSL_process_hs). The error may be indicated to the administrator by the human readable text “no shared cipher.”

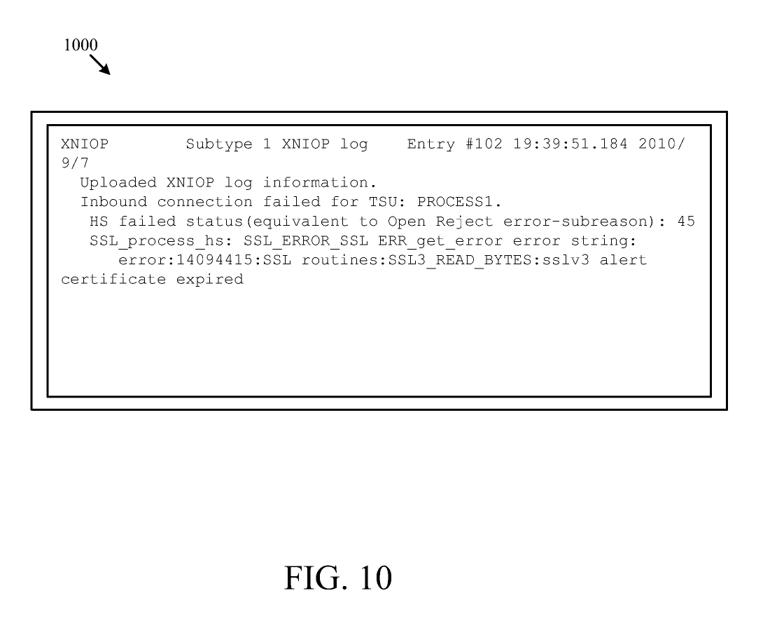

Another example log file entry is illustrated in FIG. 10. FIG. 10 is an example terminal output illustrating an exemplary log file entry according to another embodiment of the disclosure. A log file entry 1000 may indicate to an administrator that the certificate in use by CPCommOS is expired causing the client to reject the certificate and the SSL and/or TLS handshake to fail.

The method described above is advantageous to reduce the number of steps for an administrator to view communications log files and subsequently to analyze failed communication attempts. In conventional solutions, after a remote client failed to establish a communication session with the server the pass-through communications processor (e.g., CPCommOS) did not receive notification of the failure. Thus, the remote client would have to manually report the error to the administrator of the server. According to the present disclosure, when a communication attempt is made to the server an indication is provided to the communications processor including information about the communications attempt. The communications processor in the operating system creates a communications log with the information, which is available to administrators to quickly and easily diagnose failed communications attempts. The method disclosed may be particularly advantageous when diagnosing SSL and/or TLS communications attempts, which often involve the creation and management of certificates, certificate trust, private and public keys, and/or cipher suites. Having information about which of these steps in the SSL and/or TLS handshake failed allows the administrator to quickly resolve communications issues affecting the server.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method, comprising:
receiving, at an interface, a connection attempt to an operating system;
logging the connection attempt in a first log at the interface; and
sending, to the operating system, an indication of the connection attempt.

2. The method of claim 1, further comprising logging the connection attempt in a second log at the operating system.

3. The method of claim 2, further comprising:
closing the second log file; and
analyzing the second log file.

4. The method of claim 3, in which analyzing the second log file comprises executing an log analysis application in the operating system.

5. The method of claim 1, in which the connection attempt is at least one of a secure sockets layer (SSL) connection and a transport layer security (TLS) connection.

6. The method of claim 1, in which when the connection attempt fails the indication comprises a message packet having error information.

7. The method of claim 1, in which when the connection attempt succeeds the indication comprises a message packet having an open communications notification.

8. The method of claim 1, in which sending the indication only occurs when the connection attempt is one of a predefined group of connection attempts.

9. The method of claim 1, in which the interface and operating system are components of a computer server.

10. A computer program product, comprising:
a computer readable medium, comprising:
code to receive, at an interface, a connection attempt to an operating system;
code to log the connection attempt in a first log at the interface; and
code to send, to the operating system, an indication of the connection attempt.

11. The computer program product of claim 10, in which the medium further comprises code to log the connection attempt in a second log at the operating system.

12. The computer program product of claim 10, in which the code to send the indication comprises code to send a message packet.

13. The computer program product of claim 12, in which the code to send a message packet comprises code to send information regarding the failure of at least one of a security certificate, a private key, a public key, and a cipher suite.

14. The computer program product of claim 11, in which the medium further comprises:
code to close the second log file; and
code to analyze the second log file.

15. The computer program product of claim 14, in which the code to analyze the second log file comprises a log trace analyzer.

16. A system, comprising:
a network interface card;
a system architecture interface layer (SAIL) coupled to the network interface card; and
an operating system coupled to the SAIL, and
in which the operating system comprises a pass-through communications processor,
in which the SAIL comprises an interface processor for indicating to the communications processor communications attempts received through the network interface card.

17. The system of claim 16, in which the interface processor is configured to receive at least one of a secure sockets layer (SSL) connection and a transport layer security (TLS) connection.

18. The system of claim 16, in which the communications processor is configured to create a communications log storing indications of communications attempts received from the communications processor.

19. The system of claim 18, in which the communications processor is further configured to analyze the communications log.

20. The system of claim 16, in which the system is a server configured for access by remote users.
